(19) United States
(12) Patent Application Publication
(10) Pub. No.: US 2015/0303467 A1
(43) Pub. Date: Oct. 22, 2015

(54) ANODE COMPOSITIONS FOR SODIUM-ION BATTERIES AND METHODS OF MAKING SAME

(71) Applicant: 3M INNOVATIVE PROPERTIES COMPANY, St. Paul, MN (US)

(72) Inventors: Mark N. Obrovac, Nova Scotia (CA); Leah D. Ellis, Nova Scotia (CA); John S. Thorne, Nova Scotia (CA)

(21) Appl. No.: 14/646,024

(22) PCT Filed: Nov. 20, 2013
(86) PCT No.: PCT/US13/70937

§ 371 Date: May 20, 2015

Related U.S. Application Data
(60) Provisional application No. 61/729,093, filed on Nov. 21, 2012.

(51) Int. Cl. H01M 4/38; H01M 10/056; H01M 4/583; H01M 10/054

(52) U.S. Cl. CPC H01M 4/387; H01M 10/054; H01M 4/381; H01M 10/056; H01M 4/583; H01M 2220/30; H01M 2220/20

(57) ABSTRACT

A sodium ion battery. The battery includes a cathode that includes sodium, an electrolyte that include sodium, and an electrochemically active anode material. The electrochemically active anode material includes an electrochemically active phase and an electrochemically inactive phase. The electrochemically active phase and the electrochemically inactive phase share at least one common phase boundary. The electrochemically active phase does not comprise oxygen, sulfur, or a halogen. The electrochemically active phase is essentially free of crystalline grains that are greater than 40 nm.

### CROSS REFERENCE TO RELATED APPLICATIONS

This application claims the benefit of U.S. Provisional Application No. 61/729,093, filed Nov. 21, 2012, the disclosure of which is incorporated by reference herein in its entirety.

### FIELD

The present disclosure relates to compositions useful as anodes for sodium-ion batteries and methods for preparing and using the same.

### BACKGROUND

Various anode compositions have been introduced for use in secondary sodium-ion batteries. Such compositions are described, for example, in Jiang Wei Wang et al., “Microstructural Evolution of Tin Nanoparticles during In Situ Sodium Insertion and Extraction”, Nano Letters; Yunhua Xu et al., “Electrochemical Performance of Porous Carbon/Tin Composite Anodes for Sodium-Ion and Lithium-Ion Batteries”, Advanced Energy Materials; Lifen Xiao et al., “High capacity, reversible alloying reactions in SnSb/C nanocomposites for Na-ion battery applications”, Chem. Comm. 48 (2012) 3321; U.S. Pat. App. Pub. 2012/0199785; Tuan T. Tran et al., “Alloy Negative Electrodes for High Energy Density Metal-Ion Cells”, J. Electrochem. Soc. 158 (2011) A1411; and V. L. Chevrier et al., “Challenges for Na-ion Negative Electrodes”, J. Electrochem. Soc. 158 (2011) A1011.

### SUMMARY

In some embodiments, a sodium ion battery is provided. The battery includes a cathode that includes sodium, an electrolyte that include sodium, and an electrochemically active anode material. The electrochemically active anode material includes an electrochemically active phase. The electrochemically active phase includes an electrochemically active chemical element and an electrochemically inactive chemical element. The electrochemically active chemical element does not comprise oxygen, sulfur, or a halogen. The electrochemically active phase is essentially free of crystalline grains that are greater than 40 nm.

In various embodiments, a sodium ion battery is provided. The battery includes a cathode that includes sodium, an electrolyte that include sodium, and an electrochemically active anode material. The electrochemically active anode material includes an electrochemically active phase and an electrochemically inactive phase. The electrochemically active phase and the electrochemically inactive phase share at least one common phase boundary. The electrochemically active phase does not comprise oxygen, sulfur, or a halogen. The electrochemically active phase is essentially free of crystalline grains that are greater than 40 nm.

In illustrative embodiments, a method of making a sodium battery is provided. The method includes providing a cathode comprising sodium and providing an anode. Providing the anode includes combining precursors of the electrochemically active anode material and ball milling the precursors. The method further includes incorporating the cathode and anode into a battery comprising an electrolyte. The electrolyte includes sodium.

The above summary of the present disclosure is not intended to describe each embodiment of the present invention. The details of one or more embodiments of the disclosure are also set forth in the description below. Other features, objects, and advantages of the invention will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIG. 1 shows discharge capacity vs. cycle number for Comparative Example 1, and for negative electrodes containing the material of Example 2 as the active material at 60° C. and 30° C.;

FIG. 2 shows an x-ray diffraction pattern of the powder of Example 2;

FIG. 3 shows the x-ray diffraction patterns of the samples of Examples 1-4;

FIG. 4 shows the voltage curve of cells constructed with the negative electrodes of Examples 1-4 as the active material;

FIG. 5 shows the x-ray diffraction pattern of the sample of Example 5;

FIG. 6 shows the voltage curve of the sample of Example 5 in a sodium half cell; and

FIG. 7 shows the capacity of the cell of Example 5 as a function of cycle number.

### DETAILED DESCRIPTION

Sodium ion batteries are of interest as a low-cost, high energy density battery chemistry. Hard carbons have been suggested as suitable negative electrode materials for use in sodium-ion batteries. However, hard carbons have volumetric capacities of only about 450 Ah/L. This is less than two-thirds the volumetric capacity of graphite in a lithium-ion cell.

Alloy based high energy density negative electrode materials have been introduced as an alternative to hard carbons. However, problems with known alloy based electrode materials include that they experience large volume expansion during battery operation as a result of sodiation and desodiation, and that they have poor cycle life.

Generally, the present disclosure relates to high energy density negative electrode materials having low volume expansion and improved cycle life. The negative electrode material can be made from alloy particles containing an electrochemically active phase. The alloy particles may also contain an electrochemically inactive chemical element or phase. The alloy particles may be free of phases with crystalline grains exceeding 40 nanometers.

While not intending to be bound by theory, it is believed that by including an inactive chemical element or phase, the volume expansion at full sodiation is limited, and that by ensuring that the crystalline grain size is less than 40 nanometers, the cycle life is improved.

### Definitions

In this document:

the terms “sodiate” and “sodiation” refer to a process for adding sodium to an electrode material;

the terms “desodiate ” and “desodiation” refer to a process for removing sodium from an electrode material;

the terms “charge” and “charging” refer to a process for providing electrochemical energy to a cell;

the terms “discharge” and “discharging” refer to a process for removing electrochemical energy from a cell, e.g., when using the cell to perform desired work;

the term “cathode” refers to an electrode (often called the positive electrode) where electrochemical reduction and sodiation occurs during a discharging process;

the term “anode” refers to an electrode (often called the negative electrode) where electrochemical oxidation and desodiation occurs during a discharging process;

the term “alloy” refers to a substance that includes any or all of metals, metalloids, semimetals;

the phrases “electrochemically active anode material” or “active anode material” refer to an active material that is a component of the anode of a sodium ion battery;

the phrases “electrochemically active material” or “active material” refer to a material, which can include a single phase or a plurality of phases, that reversibly reacts with sodium under conditions typically encountered during charging and discharging in a sodium-ion battery;

the phrases “electrochemically active phase” or “active phase” refer to a phase of an electrochemically active material that reversibly reacts with sodium under conditions typically encountered during charging and discharging in a sodium-ion battery;

the phrases “electrochemically inactive phase” or “inactive phase” refer to a phase of an electrochemically active material that does not react with sodium under conditions typically encountered during charging and discharging in a sodium-ion battery;

the phrases “electrochemically active chemical element” or “active chemical element” refer to chemical elements that reversibly react with sodium under conditions typically encountered during charging and discharging in a sodium-ion battery;

the phrases “electrochemically inactive chemical element” or “inactive chemical element” refer to chemical elements that do not react with sodium under conditions typically encountered during charging and discharging in a sodium-ion battery;

the term “amorphous” refers to a material that lacks the long range atomic order characteristic of crystalline material, as observed by x-ray diffraction or transmission electron microscopy;

the phrase “nanocrystalline phase” refers to a phase having crystalline grains no greater than about 40 nanometers (nm);

the term “powder” refers to a material which exists in a particulate form comprising a plurality of particles wherein the average size of the particles is below 200 micrometers;

the phrase “thin film” refers to a layer of one or more materials formed to an average thickness of less than 100 micrometers; and

the phrase “essentially free” means that the material recited before this phrase does not include an amount of the material recited after this phrase that would materially affect the properties of the material recited before this phrase.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

In some embodiments, the present disclosure relates sodium ion batteries. The sodium ion batteries may include a cathode composition that includes sodium and an electrolyte composition that includes sodium. The sodium ion batteries may further include an anode that includes an electrochemically active anode material. Generally, the electrochemically active anode material may include one or more electrochemically active phases, where the electrochemically active phase is in the form of or includes an active chemical element (excluding oxygen, sulfur or a halogen), an alloy, or combinations thereof. In some embodiments, the electrochemically active phase may include elemental tin, carbon, gallium, indium, silicon, germanium, lead, antimony, bismuth, and combinations thereof. The electrochemically active phase may include elemental tin, carbon, or combinations thereof. In some embodiments, the electrochemically active phase does not comprise nitrogen. In some embodiments, the electrochemically active phase may comprise an inactive chemical element, including aluminum, boron, transition metals (e.g., titanium, vanadium, chromium, manganese, iron, cobalt, nickel, copper) alkaline earth metals, rare earth metals, or combinations thereof. The electrochemically active anode material may be in the form of a powder or a thin film.

In some embodiments the electrochemically active anode material may comprise an electrochemically inactive phase, such that the electrochemically active phase and the electrochemically inactive phase share at least one common phase boundary. In various embodiments, the electrochemically inactive phase may be in the form of or include an electrochemically inactive chemical element, including aluminum, boron, transition metals (e.g., titanium, vanadium, chromium, manganese, iron, cobalt, nickel, copper) alkaline earth metals, rare earth metals, or combinations thereof. In various embodiments, the electrochemically inactive phase may be in the form of an alloy. In various embodiments, the electrochemically inactive phase may include a transition metal or combinations thereof. The electrochemically inactive phase may include a first row transition metal element, such as, for example, titanium, vanadium, chromium, manganese, iron, cobalt, nickel, copper, and combinations thereof. The electrochemically inactive phase may include cobalt, copper, and combinations thereof. The electrochemically inactive phase may include boron or aluminum, and combinations thereof. In some embodiments, the electrochemically inactive phase may comprise an active chemical element, including tin, carbon, gallium, indium, silicon, germanium, lead, antimony, bismuth and combinations thereof. The electrochemically inactive phase may include compounds such as silicides, aluminides, borides, nitrides or stannides. The electrochemically inactive phase may include oxides, such as titanium oxide, zinc oxide, silicon oxide, aluminum oxide or sodium-aluminum oxide.

In some embodiments, an electrochemically active anode material for a sodium-ion battery may have the formula:

SnₓM_{(100-x-y)}C_{z},

where M is one or more metal elements, and where x is at least 5, at least 20, or at least 60; x is less than 90, x is less than 50, or x is less than 10; x is 10 to 30, 30 to 60, or 60 to 90; y is at least 5, at least 20, or at least 60; y is less than 90, y is less than 50, or y is less than 30; or y is 10 to 30, 30 to 60, or 60 to 90; and (1-x-y) is at least 5, at least 20, or at least 50; z is less than 60, z is less than 30, or z is less than 10; or z is 5 to 10, 10 to 20, or 20 to 30. In various embodiments, M may include one or more metal elements selected from titanium, vanadium, chromium, manganese, iron, cobalt, nickel, copper, magnesium lanthanum, aluminum, boron, and combinations thereof.

In illustrative embodiments, specific examples of anode compositions may include those having the formulae Sn₃₀CO₃₀C₄₀, Sn₂₅Cu₃₁C₄₄, Sn₃₀Fe₃₀C₄₀ or Sn₅₀Mn₁₀C₄₀. In other illustrative embodiments, specific examples of anode compositions may include those having the formulae MnSb, NiSb₂, Sn₄(SiO₂)₂, Sn₄(TiN)₃, SnAl₂, and Pb₆₀La₂₀Al₃₀.

In illustrative embodiments, any electrochemically active phase(s) and any electrochemically inactive phase(s) of the electrochemically active anode material may be nanocrystalline and be free of crystalline grains greater than 40 nm, greater than 30 nm, greater than 20 nm, greater than 10 nm, or even greater than 5 nm. Alternatively, one of the of the electrochemically active phase and the electrochemically inactive phase may be amorphous and the other may be nanocrystalline and be free of crystalline grains greater than 40 nm, greater than 30 nm, greater than 20 nm, greater than 10 nm, or even greater than 5 nm. In a further alternative, only the electrochemically active phase may nanocrystalline and be free of crystalline grains greater than 40 nm, greater than 30 nm, greater than 20 nm, greater than 10 nm, or even greater than 5 nm, or amorphous. Still further, each of the electrochemically active phase and the electrochemically inactive phase may be amorphous. Yet further, the electrochemically active anode material may be essentially amorphous (i.e. the electrochemically active anode material may not include any non-amorphous phases/components that would materially affect the properties of the material). In various embodiments, the electrochemically active anode material may be completely free of crystalline grains greater than 40 nm in size. Generally, the size of crystalline grains, if present, can be determined from the width of an x-ray diffraction peak using the Scherrer equation. Narrower x-ray diffraction peaks correspond to larger grain sizes. The x-ray diffraction peaks for nanocrystalline materials typically can have a peak width at half the maximum peak height corresponding to greater than 0.5 degrees 2θ, greater than 1 degree 2θ, greater than 2 degrees 2θ, greater than 3 degrees 2θ, or greater than 4 degrees 2θ using a copper target (i.e., copper Kα1 line, copper Kα2 line, or a combination thereof), where 2θ is in a range from 10° to 80°.

In some embodiments, anodes comprising the electrochemically active anode materials of the present disclosure may further include one or more additives such as binders, conductive diluents, fillers, adhesion promoters, thickening agents for coating viscosity modification such as carboxymethylcellulose, polyacrylic acid, polyvinylidene fluoride, carbon black and other additives known by those skilled in the art. In some embodiments, anodes comprising the electrochemically active anode materials of the present disclosure may further include other active anode materials, such as hard carbons as described in D. A. Stevens and J. R. Dahn, J. Electrochem. Soc., 148 (2001) A803 or metal oxide active anode materials, such as Na₂Ti₃O₇, as described in Premkumar Senguttuvan, Gwenaelle Rousse, Vincent Seznec, Jean-Marie Tarascon, and M. Rosa Palacin, Chem. Mater. 23 (2011) 4109.

In some embodiments, anodes comprising the electrochemically active anode materials of the present disclosure may can have high specific capacity (mAh/g) retention (i.e., improved cycle life) when incorporated into a sodium ion battery and cycled through multiple charge/discharge cycles. For example, such anodes can have a specific capacity of greater than 50 mAh/g, greater than 100 mAh/g, greater than 500 mAh/g, or even greater than 1000 mAh/g when the battery is cycled between 0 and 2V or 5 mV and 1.2V vs. Na and the temperature is maintained at about room temperature (25° C.) or at 30° C. or at 60° C. or even higher.

In some embodiments, anodes comprising the electrochemically active anode materials of the present disclosure, when incorporated into a sodium ion battery, may expand when they undergo sodiation. It may be desirable to limit the volume expansion of the anodes. This may be accomplished, for instance, by including one or more inactive chemical elements. In illustrative embodiments, the anodes may have a volume expansion of less than 200%, less than 150%, less than 120%, or even less than 100%.

The present disclosure further relates to methods of making the above-described electrochemically active anode materials. In various embodiments, the electrochemically active anode compositions can be synthesized by any method suitable for obtaining nanocrystalline or amorphous phases, e.g., a rapid solidification method, an ultra rapid solidification method, a mechanical processing method, a sputtering method, an atomizing method, a milling method, a low energy roller milling method as described in U.S. Pat. No. 8,257,864. The electrochemically active anode material may also be heated after the above described processing method, so long as the heating does not cause the formation of crystalline grains of the active phase to exceed 40 nm. In some embodiments, any heating step does not cause the formation of any crystalline grains in the active anode material to exceed 40 nm.

The present disclosure further relates to methods of making an electrode. In some embodiments, the method may include mixing the above-described the electrochemically active anode materials, along with any additives such as binders, conductive diluents, fillers, adhesion promoters, thickening agents for coating viscosity modification and other additives known by those skilled in the art, in a suitable coating solvent such as water or N-methylpyrrolidinone to form a coating dispersion or coating mixture. The dispersion may be mixed thoroughly and then applied to a foil current collector by any appropriate coating technique such as knife coating, notched bar coating, dip coating, spray coating, electrospray coating, or gravure coating. The current collectors may be thin foils of conductive metals such as, for example, copper, aluminum, stainless steel, or nickel foil. The slurry may be coated onto the current collector foil and then allowed to dry in air or vacuum, and optionally by drying in a heated oven, typically at about 80° to about 300° C. for about an hour to remove the solvent.

The electrodes of the present disclosure are particularly useful as negative electrodes for sodium-ion batteries. To prepare a battery, the negative electrode may be combined with an electrolyte and a cathode. Examples of suitable cathodes include sodium containing cathodes, such as sodium transition metal oxides of the formula NaₓMO₂, were M is a transition metal and x is from 0.7 to 1.2. Specific examples of suitable cathode materials include NaCrO₂, NaCoO₂, NaNi_{0.5}Mn_{0.5}O₂, NaMn_{0.5}Fe_{0.5}O₂. The electrolyte may be in the form of a liquid, solid, or gel. Electrolytes normally comprise a salt and a solvent. Examples of solid electrolyte solvents include polymers such as polyethylene oxide, polytetrafluoroethylene, fluorine-containing copolymers, and combinations thereof Examples of liquid electrolyte solvents include ethylene carbonate, diethyl carbonate, propylene carbonate, and combinations thereof. Examples of electrolyte salts include sodium containing salts, such as NaPF₆ and NaClO₄, Na[N(SO₂CF₃)₂]₂, NaCF₃SO₃ and NaBF₄. A microporous separator, such as a microporous material available from Celgard LLC, Charlotte, N.C., may be incorporated into the battery and used to prevent the contact of the negative electrode directly with the positive electrode.

The disclosed electrochemical cells can be used in a variety of devices including, without limitation, portable computers, tablet displays, personal digital assistants, mobile telephones, motorized devices (e.g., personal or household appliances and vehicles), instruments, illumination devices (e.g., flashlights) and heating devices. One or more electrochemical cells of this invention can be combined to provide battery pack.

The operation of the present disclosure will be further described with regard to the following detailed examples. These examples are offered to further illustrate various specific embodiments and techniques. It should be understood, however, that many variations and modifications may be made while remaining within the scope of the present disclosure.

### EXAMPLES

### X-Ray Diffraction Measurement

XRD patterns were measured on an x-ray powder diffractometer equipped with a Cu-target X-ray tube and a diffracted beam monochromater. Measurements were taken from 10-70 degrees 2-theta, with 0.05 degrees per step, and a 10 second count time.

Preparation of (Sn_{0.5}Co_{0.5})₁₋ₓCₓ

CoSn₂ was produced by arc melting elemental Sn (Sigma-Aldrich, <150 μm, 99.5%) and Co followed by annealing, respectively, at 500° C. for 24 h and under flowing argon. The annealed material was then ground into powder. 2,215 0.64 cm diameter stainless steel balls and 30 g of a stoichiometric mixture of the CoSn₂ powder, Co (Sigma-Aldrich, <150 μm, 99.9+%), and graphite (Fluka, purum) to give the final composition (Sn_{0.5}Co_{0.5})₁₋ₓCₓ were added in an argon atmosphere to a horizontal rolling mill vial with a diameter of 16.5 cm and a width of 1.6″. The vial was then roller milled at a rotational speed of 106 rpm for 336 hours.

### Electrode Coating Preparation

(Sn_{0.5}Co_{0.5})₁₋ₓCₓ, CoSn₂ or Sn (Sigma-Aldrich, <150 μm, 99.5%) electrodes were made by combining the active powder in a slurry with polyacrylic acid (35% solution in water, Aldrich) in a 90:10 weight ratio. Deionized water was added to give the slurry a proper viscosity. The slurry was mixed for one hour in a planetary mill at 120 rpm with two tungsten carbide balls. The slurry was then coated using a doctor blade with a 0.002″ gap onto copper foil and air dried in a convection oven at 90° C. for 4 hours.

### Coin Cell Construction

### Comparative Examples 1-3 and Examples 1-4

Electrodes 1.3 cm² in area, and having a theoretical capacity of about 1 mAh/cm², were punched from the electrode coatings described above. The electrodes were incorporated as working electrodes in 2325 type coin cells with Na metal (Aldrich, ACS grade, rolled into foil) as the counter electrode and 1M NaPF₆ (Aldrich, 98%) in EC/DEC (1:2 by volume) electrolyte (Novolyte Technologies). Two layers of Celgard 2301 and one layer of polypropylene blown microfiber (3M Co.) were used as separators.

### Electrochemical Testing

### Comparative Examples 1-3 and Examples 1-4

Electrochemical tests were performed using a Maccor Series 4000 Automated Test System. Coin cells were cycled using a cell tester (Maccor Inc., Tulsa Okla.), between 5 mV and 1.2 V at a rate of C/25 in a thermostatically controlled chamber at either 30° C. or 60° C. After full sodiation was achieved, the cells were held at a constant potential of 5 mV until the current decreased to C/50.

### Comparative Example 1

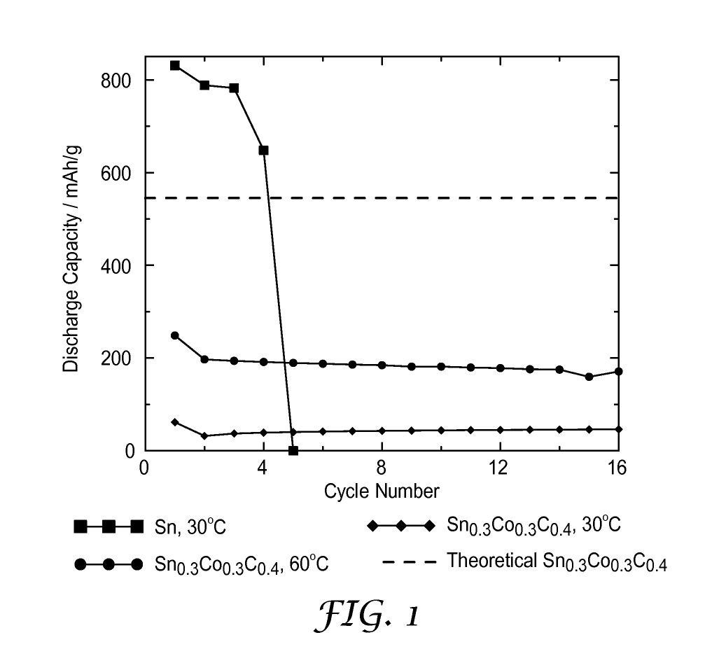

An electrode using pure crystalline Sn having a grain size of about 42 nm, according to the Scherrer Equation, was prepared and cycled in an electrochemical cell. The cycling performance is shown in FIG. 1. After 4 charge/discharge cycles the capacity fades to zero.

### Comparative Example 2

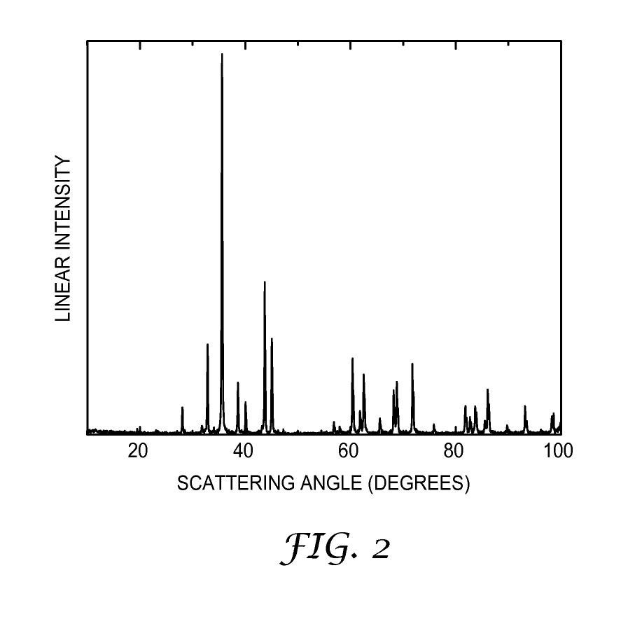

An ingot of CoSn₂ was prepared by melting 0.7378 g of cobalt and 3.0364 g of tin in an arc furnace. The ingot was then heated under argon at 125° C. for 2 hours followed by heating at 510° C. for 60 hours, then cooling to room temperature and finally ground into a powder and passed through a 53 μm sieve. An x-ray diffraction pattern of the powder, shown in FIG. 2, shows that it consists of single phase CoSn₂. According to the Scherrer equation, this powder consists of CoSn₂ with having a grain size of 73 nm. Electrochemical cells were tested with coatings made from the CoSn₂ powder. These cells did not have any capacity. The CoSn₂ of this example was electrochemically inactive in a sodium cell.

### Comparative Example 3

An electrochemical cell was made using the same technique of Example 2, except replacing sodium foil with lithium foil (cut from 0.38 mm thick lithium ribbon, available from Aldrich, Milwaukee, Wis.) and replacing the electrolyte with 1M LiPF₆ in ethylene carbonate (EC):diethylene carbonate (DEC) (1:2 v/v) (Novolyte Technologies). In contrast to the sodium cell, the lithium cell was able to be charged and discharged and had a first discharge capacity of 600 mAh/g.

### Examples 1-4

TABLE 1

| Example | Composition |
|---|---|
| Example 1 | (Sn_{0.5}Co_{0.5})_{0.8}C_{0.2} |
| Example 2 | (Sn_{0.5}Co_{0.5})_{0.6}C_{0.4} |
| Example 3 | (Sn_{0.5}Co_{0.5})_{0.5}C_{0.5} |
| Example 4 | (Sn_{0.5}Co_{0.5})_{0.4}C_{0.6} |

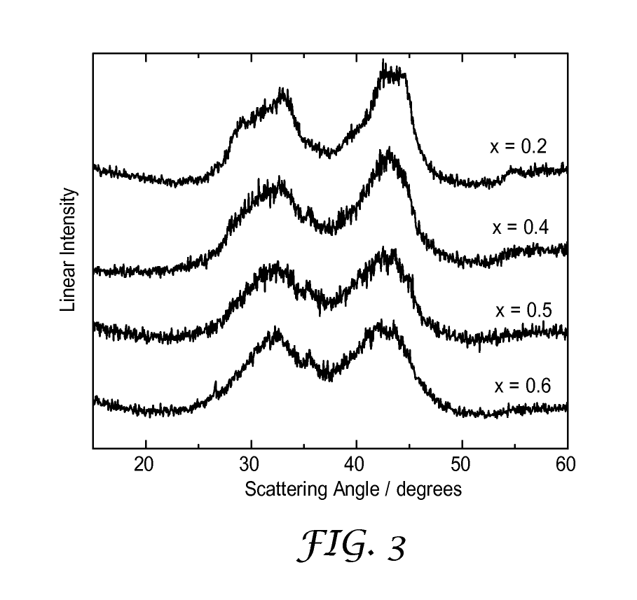

FIG. 3 shows the x-ray diffraction patterns of as prepared (Sn_{0.5}Co_{0.5})₁₋ₓCₓ samples with x>0. These samples are summarized in Table 1. The patterns show two broad peaks at 30° and 45°. These two peaks are characteristic to amorphous or nanocrystalline SnCo. According to the Scherrer equation, the SnCo phase has a grain size of roughly 1.4 nm and is essentially amorphous. A small peak at 36° indicates a small amount of unreacted CoSn₂ starting material. This phase was present in samples with x>0.2. According to the Scherrer equation, the CoSn₂ phase has a grain size of roughly 10.4 nm. No larger crystalline grains were detected.

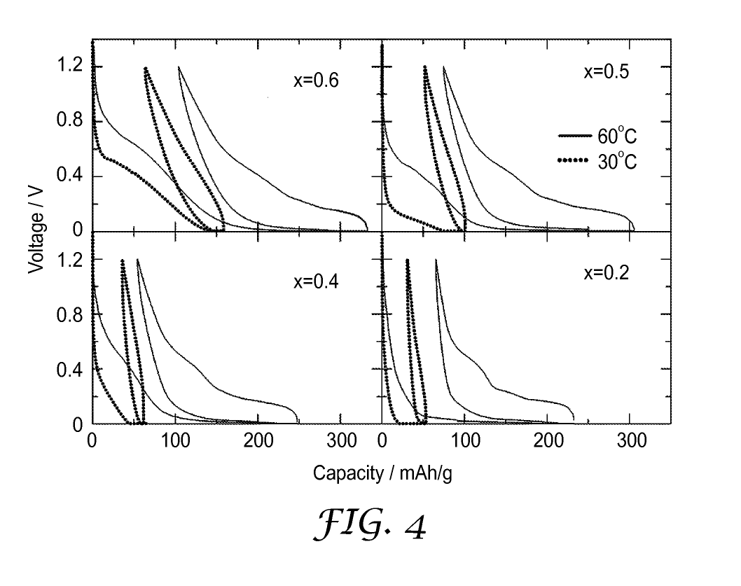

FIG. 4 shows the voltage curve of cells constructed with negative electrodes containing Examples 1-4 as the active material. The cells were cycled at 60° C. and 30° C. Higher capacity could be obtained when the Sn content was high or at higher cycling temperature.

FIG. 1 shows a plot of the cycle life of the cells made with negative electrodes containing Example 2 as the active material at 60° C. and 30° C. The electrode capacity remains almost constant after 16 cycles.

### Example 5

A thin film of Sn₂₅Cu₃₁C₄₄ was prepared by sputtering from targets which were 5.08 cm in diameter. Cu targets were cut from a 0.635 cm thick Cu plate (99.9% purity). A 0.635 cm Carbon sputtering target was obtained from Kurt J. Lesker Co. Clairton, Pa. (99.999% purity). A tin sputtering target was cut from a 0.33 cm thick Sn plate obtained from Alfa Aesar Ward Hill, Mass. All targets were mounted on 0.318 cm thick copper backing plates using SilverTech PT-1 silver epoxy from Williams Advanced Materials, Buffalo, N.Y. The Sn, Cu and C targets were energized using MDX-IK DC power supplies, available from Advanced Energy, Fort Collins, Colo. at target powers of 16 W, 28 W and 148 W, respectively. The composition of the film was verified by electron microprobe measurements were made with a JEOLJXA-8200 Superprobe.

Sodium half cells were constructed using sputtered materials deposited on 1.267 cm² circular Cu discs and incorporated into 2325 size coin-type cells using electrolyte containing 1M NaPF₆ dissolved in 1:2 EC:DEC. Two Celgard separators, one blown polypropylene microfiber separator and a sodium foil counter/reference electrode were used in cell construction. Assembly took place in an Ar filled glovebox. A spring and stainless steel spacer were used to ensure a constant stacking pressure. Cells were cycled using a cell tester (Maccor Inc., Tulsa Okla.) at 30° C. assuming a C/10 rate using a constant current assuming a calculated capacity of 15/4 Na per Sn atom based on the measured composition. X-ray diffraction measurements were performed on films sputtered on a Si wafer using an INEL CPS 120 curved position-sensitive detector coupled to an X-ray generator equipped with a Cu target X-ray tube. A monochromator in the incident beam path limited the wavelengths striking the sample due to Cu Kα radiation.

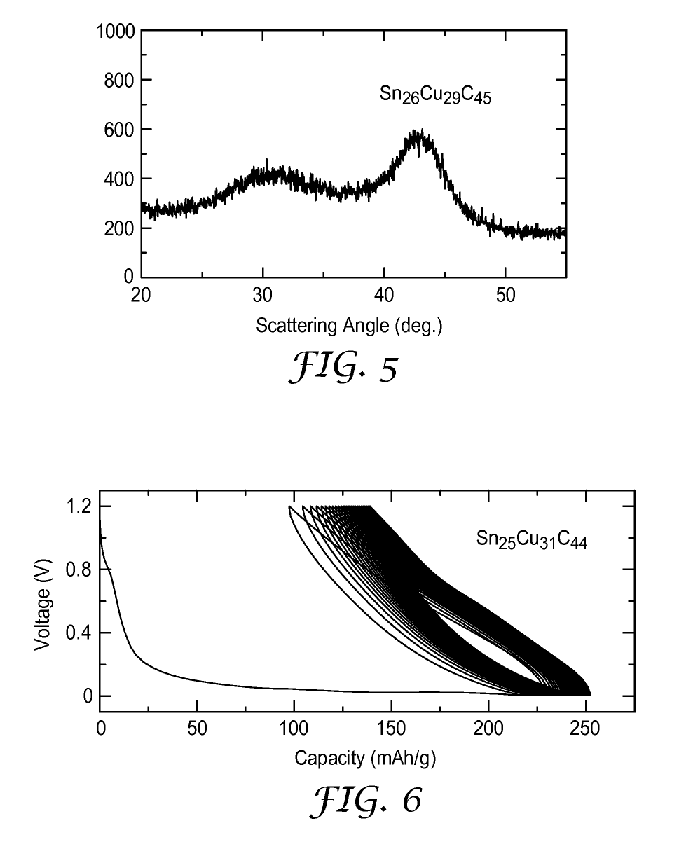

FIG. 5 shows the XRD pattern of the Sn₂₅Cu₃₁C₄₄ sample. The sample is completely amorphous.

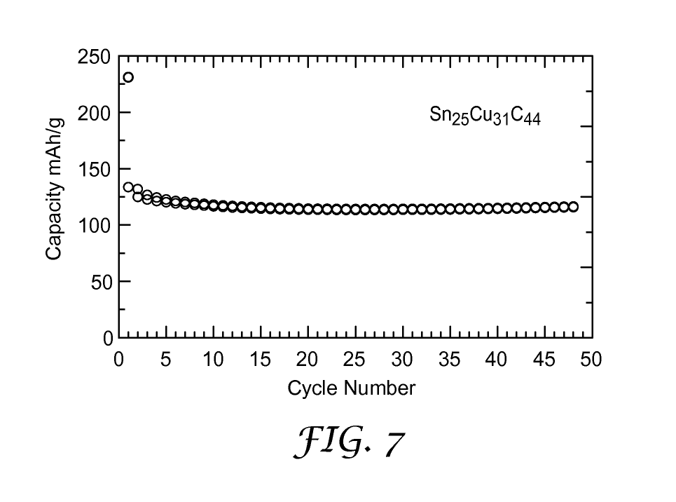

FIG. 6 shows the voltage curve of the Sn₂₅Cu₃₁C₄₄ sample in a sodium half cell and FIG. 7 shows the capacity of this cell as a function of cycle number. No capacity fade is observed between cycles 10-48.

1. A sodium ion battery comprising:
a cathode comprising sodium;
an electrolyte comprising sodium; and
an electrochemically active anode material, the electrochemically active anode material comprising an electrochemically active phase comprising
an electrochemically active chemical element; and
an electrochemically inactive chemical element;
wherein the electrochemically active chemical element does not comprise oxygen, sulfur, or a halogen; and
wherein the electrochemically active phase is essentially free of crystalline grains that are greater than 40 nm.

2. The sodium ion battery of claim 1, wherein the electrochemically active anode material comprises an electrochemically inactive phase.

3. A sodium ion battery comprising:
a cathode comprising sodium;
an electrolyte comprising sodium; and
an electrochemically active anode material, the electrochemically active anode material comprising
an electrochemically active phase; and
an electrochemically inactive phase;
wherein the electrochemically active phase and the electrochemically inactive phase share at least one common phase boundary;
wherein the electrochemically active phase does not comprise oxygen, sulfur, or a halogen; and
wherein the electrochemically active phase is essentially free of crystalline grains that are greater than 40 nm.

4. The sodium ion battery of claim 3, wherein the electrochemically active anode material is essentially free of crystalline grains greater than 40 nm.

5. The sodium ion battery of claim 3, wherein the electrochemically active anode material is essentially free of crystalline grains greater than 30 nm.

6. The sodium ion battery of claim 3, wherein the electrochemically active anode material is essentially amorphous.

7. The sodium ion battery of claim 3, wherein the electrochemically active phase is essentially amorphous.

8. The sodium ion battery of claim 3, wherein the electrochemically inactive phase is essentially free of crystalline grains that are greater than 40 nm.

9. The sodium ion battery of claim 3, wherein the electrochemically inactive phase is amorphous.

10. The sodium ion battery of claim 3, wherein both the electrochemically inactive phase and the electrochemically active phase are essentially amorphous.

11. The sodium ion battery of claims 3, wherein both the electrochemically inactive phase and the electrochemically active phase are essentially free of crystalline grains that are greater than 40 nm.

12. The sodium ion battery of claim 3, wherein the electrochemically active anode material comprises tin or carbon.

13. The sodium ion battery of claim 12, wherein the electrochemically active anode material comprises a transition metal.

14. The sodium ion battery of claim 12, wherein the electrochemically active anode material comprises an alloy.

15. The sodium ion battery of claim 3, wherein the electrochemically active anode material is in the form of a powder.

16. The sodium ion battery of claim 3, wherein the electrochemically active anode material is in the form of a thin film.

17. The sodium ion battery of claim 3, wherein the electrochemically active anode material is essentially free of crystalline grains greater than 20 nm.

18. The sodium ion battery of claim 3, wherein the electrochemically active anode material is essentially free of crystalline grains greater than 10 nm.

19. An electronic device comprising a sodium ion battery according to claim 3.

20. A method of making a sodium battery, the method comprising:
providing a cathode comprising sodium;
providing an anode, wherein providing the anode comprises combining precursors of the electrochemically active anode material according to claim 3 and ball milling the precursors; and
incorporating the cathode and anode into a battery comprising an electrolyte, wherein the electrolyte comprises sodium.
